(19) United States
(12) Patent Application Publication
(10) Pub. No.: US 2017/0118601 A1
(43) Pub. Date: Apr. 27, 2017

(54) METHOD AND DEVICE FOR PROCESSING DATA, WIRELESS ROUTER AND INTERNET OF VEHICLE SYSTEM

(71) Applicant: Leauto Intelligent Technology (BEIJING) Co. Ltd., Beijing (CN)

(72) Inventors: WenRui LI, Beijing (CN); Yong XU, Beijing (CN); Yu ZOU, Beijing (CN); KunSheng CHEN, Beijing (CN); Wei LIN, Beijing (CN); Peng LIU, Beijing (CN); Dan LI, Beijing (CN)

(21) Appl. No.: 14/978,937

(22) Filed: Dec. 22, 2015

(30) Foreign Application Priority Data
Oct. 23, 2015 (CN) 201510696401.X

(51) Int. Cl. H04W 4/06; H04L 29/06; H04L 29/08

(52) U.S. Cl. CPC H04W 4/06; H04L 67/12; H04L 69/16; H04L 69/18

(57) ABSTRACT

The present disclosure provides a method and a device for processing data, a wireless router and an Internet of Vehicles system. According to the method, by using TDM, messages are received and transmitted based on frequency point of WAVE protocol and Wi-Fi (Wireless Fidelity) protocol respectively, at physical layer; at MAC layer, a first message received based on the frequency point of WAVE protocol is subject to protocol processing by using WAVE protocol stack; at MAC layer, and a second message received based on the frequency point of Wi-Fi protocol is subject to protocol processing by using Wi-Fi protocol stack. By using such manner of combining TDM and FDM, it is possible to realize integrated processing of messages based on different protocols, enabling the current wireless router based on Wi-Fi protocol to be compatible with WAVE protocol.

### CROSS-REFERENCE TO RELATED APPLICATIONS

This application is based on and claims priority to Chinese Patent Application No. 201510696401.X, filed on Oct. 23, 2015, the full disclosure of which is hereby incorporated by reference in its entirety.

### TECHNICAL FIELD

The present disclosure relates to a field of Internet of Vehicles technology, and more particularly to a method and a device for processing data, a wireless router and an Internet of Vehicles system.

### BACKGROUND

As the development of internet technology and intellectual traffic technology, the IOV (Internet of Vehicles) system including on-vehicle device and road-side device has been in fast development. Recently, in order to adapt the repeated disconnections and re-connections of the links in IOV system and the special demands of quick accessing, a WAVE (Wireless Access in Vehicular Environment) protocol dedicated for IOV system has been generated correspondingly. This WAVE protocol is used as DSRC (Dedicated Short Range Communications) and greatly reduces the period of time required for establishing connection between on-vehicle device and rode-side device, by reducing the period of time for authentication and verifying in prior art, thereby improving the efficiency of accessing for IOV.

However, meanwhile, the deployment for rode-side devices adapted for such WAVE protocol is difficult, which becomes a big problem occurred in the development of IOV system. Such problem is caused due to the fact that WAVE protocol is a shot-range communication technology, and thus in prior art, it is generally required to deploy many such rode-side devices along roads, which increases the cost for networking of the IOV.

### SUMMARY

The embodiments of the present disclosure provide a method and a device for processing data, a wireless router and an Internet of Vehicle system, which can solve the technical problem of high cost for networking of IOV in the related art.

In the first aspect of the present disclosure, embodiments of the present disclosure provide a method for processing data including receiving messages based on frequency points of WAVE protocol and Wi-Fi (Wireless Fidelity) protocol respectively, at physical layer, using TDM (Time Division Multiplexing); performing protocol processing on a first message received based on the frequency point of WAVE protocol using WAVE protocol stack at MAC (Media Access Control) layer; and performing protocol processing on a second message received based on the frequency point of Wi-Fi protocol using Wi-Fi protocol stack at said MAC layer.

In the second aspect of the present disclosure, embodiments of the present disclosure provide a method for processing data including: performing protocol processing on a first message to be transmitted based on the frequency point of WAVE protocol using WAVE protocol stack at MAC layer; performing protocol processing on a second message to be transmitted based on the frequency point of Wi-Fi protocol using Wi-Fi protocol stack at said MAC layer; and transmitting the processed first message based on frequency point of WAVE protocol, and transmitting the processed second message based on frequency point of Wi-Fi protocol respectively, using TDM at physical layer.

In the third aspect, embodiments of the present disclosure provide a device for processing data including a receiving module configured to control physical layer to receive messages respectively based on frequency points of WAVE protocol and Wi-Fi protocol; a first processing module configured to perform protocol processing on a first message received based on the frequency point of WAVE protocol using WAVE protocol stack at MAC layer; and a second processing module configured to perform protocol processing on a second message received based on the frequency point of Wi-Fi protocol using Wi-Fi protocol stack at said MAC layer.

In the fourth aspect of the present disclosure, embodiments of the present disclosure provide a device for processing data including a first processing module configured to perform protocol processing on a first message to be transmitted based on the frequency point of WAVE protocol using WAVE protocol stack at MAC layer; a second processing module configured to perform protocol processing on a second message to be transmitted based on the frequency point of Wi-Fi protocol using Wi-Fi protocol stack at said MAC layer; and a transmitting module configured to transmit the processed first message based on frequency point of WAVE protocol, and transmit the processed second message based on frequency point of Wi-Fi protocol respectively, using TDM at physical layer.

In the fifth aspect of the present disclosure, embodiments of the present disclosure provide a device for processing data, comprising: one or more processors; a memory; and one or more programs stored in the memory and configured to perform operations when executed by the one or more processors, wherein the operations comprises: receiving messages based on frequency points of Wireless Access in Vehicular Environment protocol and Wireless Fidelity protocol using Time Division Multiplexing at physical layer respectively; performing protocol processing on a first message received based on the frequency point of WAVE protocol using WAVE protocol stack at Media Access Control layer; and performing protocol processing on a second message received based on the frequency point of Wi-Fi protocol using Wi-Fi protocol stack at said MAC layer.

In the sixth aspect of the present disclosure, embodiments of the present disclosure provide a device for processing data, comprising: one or more processors; a memory; and one or more programs stored in the memory and configured to perform operations when executed by the one or more processors, wherein the operations comprises: performing protocol processing on a first message to be transmitted based on the frequency point of WAVE protocol using WAVE protocol stack at MAC layer; performing protocol processing on a second message to be transmitted based on the frequency point of Wi-Fi protocol using Wi-Fi protocol stack at MAC layer; and transmitting the processed first message based on the frequency point of WAVE protocol, and transmitting the processed second message based on the frequency point of Wi-Fi protocol by using TDM at physical layer.

In the seventh aspect of the present disclosure, embodiments of the present disclosure provide a wireless router, including the device for processing data according to the foregoing third aspect, and the device for processing data according to the above mentioned fourth aspect.

In the eighth aspect of the present disclosure, embodiments of the present disclosure provide an IOV (Internet of Vehicles) system including the foregoing wireless router, and an on-vehicle terminal, wherein there is communication connection established between said wireless router and said on-vehicle terminal.

In the embodiments of the present disclosure, by using TDM, messages are received and transmitted based on frequency points of WAVE protocol and Wi-Fi (Wireless Fidelity) protocol respectively, at physical layer; a first message received based on the frequency point of WAVE protocol is subject to protocol processing by using WAVE protocol stack at MAC layer; a second message received based on the frequency point of Wi-Fi protocol is subject to protocol processing by using Wi-Fi protocol stack at MAC layer. By using such manner of combining TDM and FDM, it is possible to realize integrated processing of messages based on different protocols, enabling the prior wireless router based on Wi-Fi protocol to be compatible with WAVE protocol, thereby enriching the functions of current wireless router, avoiding separately deploying road-side devices only supporting WAVE protocol, and thus reducing the cost for networking of IOV.

### BRIEF DESCRIPTION OF THE DRAWINGS

FIG. 1 is a flowchart illustrating a method for processing data according to a first embodiment of the present disclosure;

FIG. 2 is a schematic diagram of time interval for broadcasting beacon frame;

FIG. 3 is a schematic diagram of software architecture;

FIG. 4 is a flowchart illustrating another method for processing data according to a second embodiment of the present disclosure;

FIG. 5 is a structural diagram of a device for processing data 50 according to a third embodiment of the present disclosure;

FIG. 6 is a structural diagram of a possible implementation of a device for processing data 50;

FIG. 7 is a structural diagram of a device for processing data 70 according to a fourth embodiment of the present disclosure;

FIG. 8 is a structural diagram of a possible implementation of the device for processing data 70;

FIG. 9 is a structural diagram of a possible implementation of the device for processing data 70;

FIG. 10 is a structural diagram of the wireless router according to a fifth embodiment of the present disclosure; and

FIG. 11 is a structural diagram of the IOV.

### DESCRIPTION OF THE EMBODIMENTS

In the following, description will be given in detail on method for processing data and device according to the embodiments of the present disclosure, in connection with the accompanying drawing.

### First Embodiment

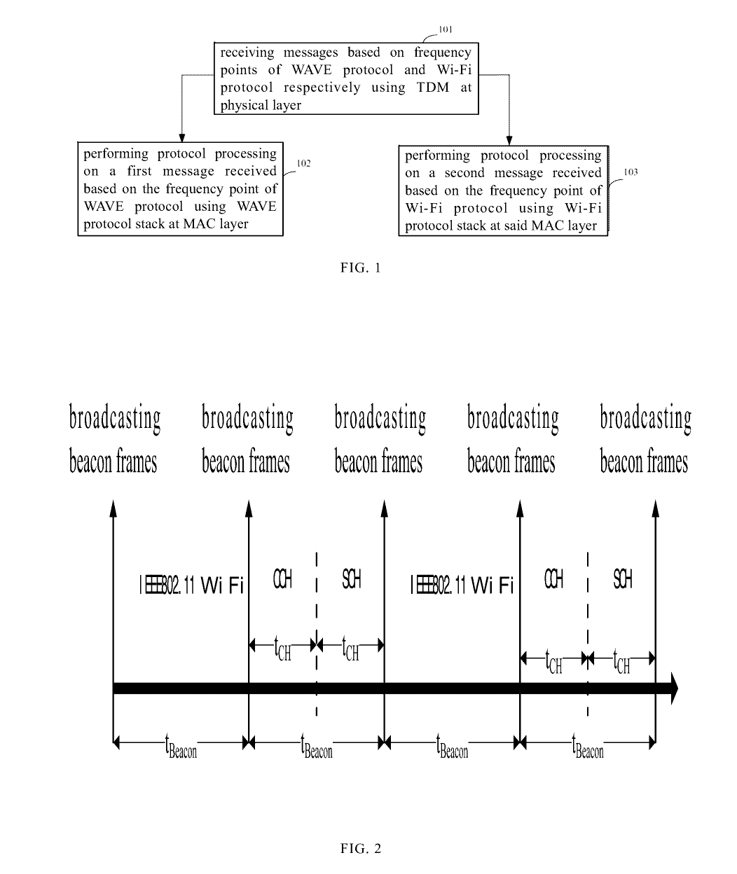

FIG. 1 is a flowchart illustrating a method for processing data according to the first embodiment of the present disclosure. The method according to the embodiment of the present disclosure may be performed by a wireless router 1. As shown in FIG. 1, the method for processing data includes:

Step 101: receiving messages based on frequency points of WAVE protocol and Wi-Fi protocol respectively using TDM at physical layer.

More particularly, according to the period of the broadcasting beacon frame in Wi-Fi protocol, messages are received based on frequency points of WAVE protocol and Wi-Fi protocol respectively at physical layer. As a possible implementation, upon the first beacon frame is broadcast, messages are received based on frequency point of WAVE protocol at physical layer; upon a second beacon frame is broadcast, messages are received based on frequency points of Wi-Fi protocol at physical layer; wherein, the time interval between broadcasting the first beacon frame and the second beacon frame is n times of the time interval for broadcasting beacon frames in Wi-Fi protocol, wherein n is an integer equal to or greater than 1. As another possible implementation, it is possible that, messages are received based on frequency points of WAVE protocol and Wi-Fi protocol respectively based on other clock, for example, based on other user-defined clock synchronization protocol, by using TDM. There is no limitation on this in the present embodiment.

For example, in the Wi-Fi mode in IEEE 802.11, a wireless router as wireless access point may broadcast beacon frame (Beacon) periodically. FIG. 2 is a schematic diagram of time interval for broadcasting beacon frame. As shown in FIG. 2, the time interval between two adjacent beacon frames is labeled as tBeacon, which is normally 100 ms, and after the first broadcasting of beacon frame in FIG. 2, messages are received based on the frequency point of Wi-Fi protocol at physical layer, until the second broadcasting of beacon frame; after the second broadcasting of beacon frame, messages are received based on the frequency point of WAVE protocol at the physical layer, until the third broadcasting of beacon frame; after the third broadcasting of beacon frame, messages are received based on the frequency point of Wi-Fi protocol at physical layer, and the above procedures may be performed repeatedly. More particularly, when messages are received based on the frequency point of WAVE protocol at physical layer, the wireless router may divide the time interval tBeacon according to the interacting manner of SCH (service channel) and CCH (control channel) defined in IEEE802.11p. In general, the most common mode is that SCH and CCH are spaced apart, and the duration period of each channel is tCH, which has a typical value of 50 ms.

In the embodiment of the present disclosure, it is possible to realize compatibility between the WAVE protocol defined in Institute of Electrical and Electronic Engineers (IEEE)802.11p and the Wi-Fi protocol defined in IEEE802.11 by using TDM mode, thereby the wireless router may support not only WAVE protocol, but also Wi-Fi protocol. The technical solution according to the present embodiment can be regarded as taking a part of time which was supposed to be used to perform Wi-Fi communication by wireless router to perform WAVE communication, and thus with respect to the wireless terminal having established Wi-Fi communication connection with the wireless router, the communication rate is reduced by 50%. When the wireless router receives messages based on Wi-Fi protocol, the on-vehicle terminal having established WAVE communication connection with the wireless router would not disconnect the communication connection, that is to say, the communication link is in communication state and only the data communication is in standby state, which means there is no data transmission and reception between the on-vehicle terminal and wireless router. When the wireless router receives messages based on WAVE protocol, the data communication between the on-vehicle terminal and wireless router is restored to perform the data transmission and reception. Therefore, it is possible to avoid the delay caused by the repeated connections between on-vehicle terminal and wireless router.

It should be noted that, for the sake of description, in the present embodiment, the time interval between broadcasting the first beacon frame and the second beacon frame may be set as being equal to the time interval of broadcasting beacon frames in Wi-Fi protocol. The embodiment of the present disclosure can also use other time interval. For example, the time interval between broadcasting the first beacon frame and broadcasting the second beacon frame is set to other integral multiple of the time interval of broadcasting beacon frames in Wi-Fi protocol.

Step 102: performing protocol processing on a first message received based on the frequency point of WAVE protocol using WAVE protocol stack at MAC layer.

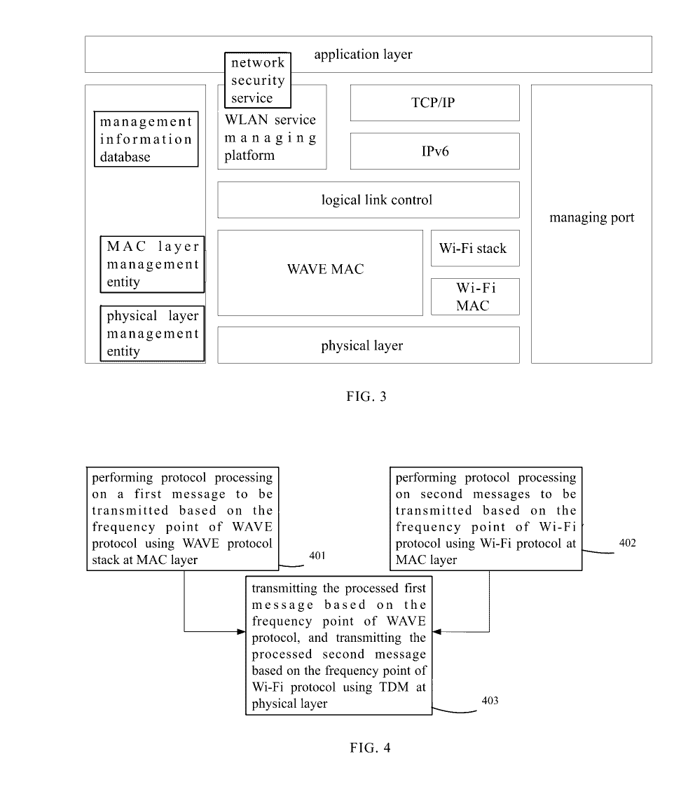

More particularly, with respect to physical layer, the physical layers of WAVE protocol and Wi-Fi protocol are compatible. That is to say, the radio frequency chip for physical layer of the present wireless router supporting Wi-Fi protocol can support WAVE protocol and Wi-Fi protocol at the same time, but with respect to the MAC layer, it is required to use different protocol stack to perform protocol processing on messages. FIG. 3 is a schematic diagram of software architecture. As shown in FIG. 3, after messages are received based on WAVE protocol and Wi-Fi protocol respectively at physical layer and protocol processing are performed, the first message received based on frequency point of WAVE protocol is subject to protocol processing by WAVE MAC protocol stack of MAC layer, and the second message received based on frequency point of Wi-Fi protocol is subject to protocol processing by Wi-Fi stack, Wi-Fi MAC protocol stack. In this procedure, the physical management entity may control physical layer to receive messages based on frequency points of WAVE protocol and Wi-Fi protocol using TDM, and the MAC layer management entity may control WAVE MAC stack to perform protocol processing on the first message received based on frequency point of WAVE protocol.

Step 103: performing protocol processing on a second message received based on the frequency point of Wi-Fi protocol using Wi-Fi protocol stack at said MAC layer.

More particularly, in the software architecture as shown in FIG. 3, the MAC layer management entity may control WAVE MAC protocol stack to perform protocol processing on the first message received based on the frequency point of WAVE protocol, and meanwhile, control Wi-Fi stack, Wi-Fi MAC protocol stack to perform protocol processing on the second message received based on the frequency point of Wi-Fi protocol.

It should be noted that, step 102 and step 103 may be performed at the same time, may be performed sequentially, and there is no limit on the performing order of step 102 and step 103 in the present embodiment.

Furthermore, after step 103, it is possible to perform logic link control protocol processing, and then perform protocol processing on the first message using WSMP (WAVEShortMessageProtocol) and/or TCP/IP (Transmission Control Protocol/Internet Protocol) protocol stack; and perform protocol processing on the second message using TCP/IP protocol stack. And then, the processed first message and processed second message may be transmitted to the application layer.

It should be noted that, network service of WAVE enables application of upper layer to select corresponding service for transmission according to the characteristic of messages. Network services provide two types of data transmission services for application of upper layer: TCP/UDP (Transmission Control Protocol/User Datagram Protocol) protocol based on IPv6 (Internet Protocol Version 6) and WSMP protocol. In IOV system (also referred as ITSITS (Intelligent Transport System)), most applications based on IP should be based on UDP in consideration of characteristic of vehicles such as high speed movement and so on, and if better transmission quality is needed, it is possible to encapsulate one higher layer protocol over UDP. WAVE defines a new link layer protocol, WSMP, which facilitates the transmission of broadcasting messages of real-time data, unreliable data, and provides the applications of upper layer an interface for accessing MAC layer and physical layer, which enables the messages to be transmitted outside as quick as possible by directly setting parameters of MAC layer and physical layer.

In the present embodiment, by using TDM, messages may be received and transmitted based on frequency points of WAVE protocol and Wi-Fi (Wireless Fidelity) protocol respectively, at physical layer; a first message received based on the frequency point of WAVE protocol may be subject to protocol processing using WAVE protocol stack at MAC layer; a second message received based on the frequency point of Wi-Fi protocol may be subject to protocol processing using Wi-Fi protocol stack at MAC layer. By using such manner of combining TDM and FDM, it may be possible to realize integrated processing of messages based on different protocols, enabling the current wireless router based on Wi-Fi protocol to be compatible with WAVE protocol, thereby enriching the functions of current wireless router, avoiding separately deploying road-side devices only supporting WAVE protocol, and thus reducing the cost for networking of IOV.

### Second Embodiment

FIG. 4 is a flowchart illustrating another method for processing data according to the second embodiment of the present disclosure. The method according to the embodiment of the present disclosure may be performed by a wireless router. As shown in FIG. 4, the method for processing data includes:

Step 401: performing protocol processing on a first message to be transmitted based on the frequency point of WAVE protocol using WAVE protocol stack at MAC layer.

More particularly, in the software architecture as shown in FIG. 3, the MAC layer management entity may control WAVE MAC protocol stack to perform protocol processing on the first message received based on the frequency point of WAVE protocol, and control Wi-Fi stack, Wi-Fi MAC protocol stack to perform protocol processing on the second message received based on the frequency point of Wi-Fi protocol.

Step 402: performing protocol processing on second messages to be transmitted based on the frequency point of Wi-Fi protocol using Wi-Fi protocol at MAC layer.

Furthermore, before step 401 and step 402, it may be necessary to determine whether the messages to be transmitted are said first messages or said second messages at the application layer. That is to say, it may be determined whether the protocol based on which the messages to be transmitted are WAVE protocol or Wi-Fi protocol at application layer. The messages to be transmitted to on-vehicle terminal may be used as first messages based on WAVE protocol, and otherwise as second messages based Wi-Fi protocol. Furthermore, the first message may be processed by using WSMP and/or TCP/IP protocol stack; and the second message may be processed by using TCP/IP protocol stack.

It should be noted that, step 402 and step 403 may be performed at the same time, may be performed sequentially, and there is no limit on the performing order of step 402 and step 403 in the present embodiment.

Step 403: transmitting the processed first message based on the frequency point of WAVE protocol, and transmitting the processed second message based on the frequency point of Wi-Fi protocol using TDM at physical layer.

More particularly, according to the period of the broadcasting beacon frame in Wi-Fi protocol, the processed first message may be transmitted based on frequency points of WAVE protocol and the processed second message may be transmitted based on frequency points of Wi-Fi protocol respectively. As a possible implementation, upon the first beacon frame is broadcast, first message may be transmitted based on frequency point of WAVE protocol at physical layer; upon a second beacon frame is broadcast, second message may be transmitted based on frequency points of Wi-Fi protocol at physical layer; wherein, the time interval between broadcasting the first beacon frame and the second beacon frame may be n times of the time interval for broadcasting beacon frames in Wi-Fi protocol, wherein n is an integer equal to or greater than 1. As another possible implementation, it is possible that, messages may be transmitted based on frequency points of WAVE protocol and Wi-Fi protocol respectively based on other clock, for example, based on other user-defined clock synchronization protocol, by using TDM. There is no limitation on this in the present embodiment.

For example, in the Wi-Fi mode in IEEE 802.11, a wireless router as wireless access point may broadcast beacon frame periodically. As shown in FIG. 2, after the first broadcasting of beacon frame, a second message may be transmitted based on the frequency point of Wi-Fi protocol at physical layer, until the second broadcasting of beacon frame; after the second broadcasting of beacon frame, a first message may be transmitted based on the frequency point of WAVE protocol at the physical layer, until the third broadcasting of beacon frame; after the third broadcasting of beacon frame, messages may be transmitted based on the frequency point of Wi-Fi protocol at physical layer, and the above procedures are repeatedly performed.

In the present embodiment, by using TDM, messages are received and transmitted based on frequency point of WAVE protocol and Wi-Fi protocol, respectively, at physical layer; a first message based on the frequency point of WAVE protocol is subject to protocol processing by using WAVE protocol stack at MAC layer; a second message based on the frequency point of Wi-Fi protocol is subject to protocol processing by using Wi-Fi protocol stack at MAC layer. By using such manner of combining TDM and FDM, it is possible to realize integrated processing of messages based on different protocols, enabling the current wireless router based on Wi-Fi protocol to be compatible with WAVE protocol, thereby enriching the functions of current wireless router, avoiding separately deploying road-side devices only supporting WAVE protocol, and thus reducing the cost for networking of IOV.

### Third Embodiment

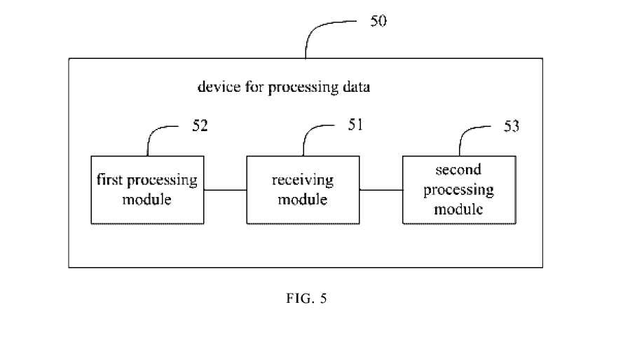

FIG. 5 is a structural diagram of a device for processing data 50 according to the third embodiment of the present disclosure. As shown in FIG. 5, the device for processing data 50 includes: a receiving module 51, a first processing module 52, and a second processing module 53.

The receiving module 51 is configured to control physical layer to receive messages based on WAVE protocol and Wi-Fi protocol respectively.

The receiving module 51 is further configured to receive messages based on frequency point of WAVE protocol and frequency point of Wi-Fi protocol at physical layer according to the period of broadcasting beacon frames in Wi-Fi protocol.

The first processing module 52 is configured to be connected with the receiving module 51, and to perform protocol processing on the first message received based on WAVE protocol using WAVE protocol stack at MAC layer.

The second processing module 53 is configured to be connected with receiving module 51 and to perform protocol processing on the second message received based on Wi-Fi protocol using Wi-Fi protocol stack at MAC layer.

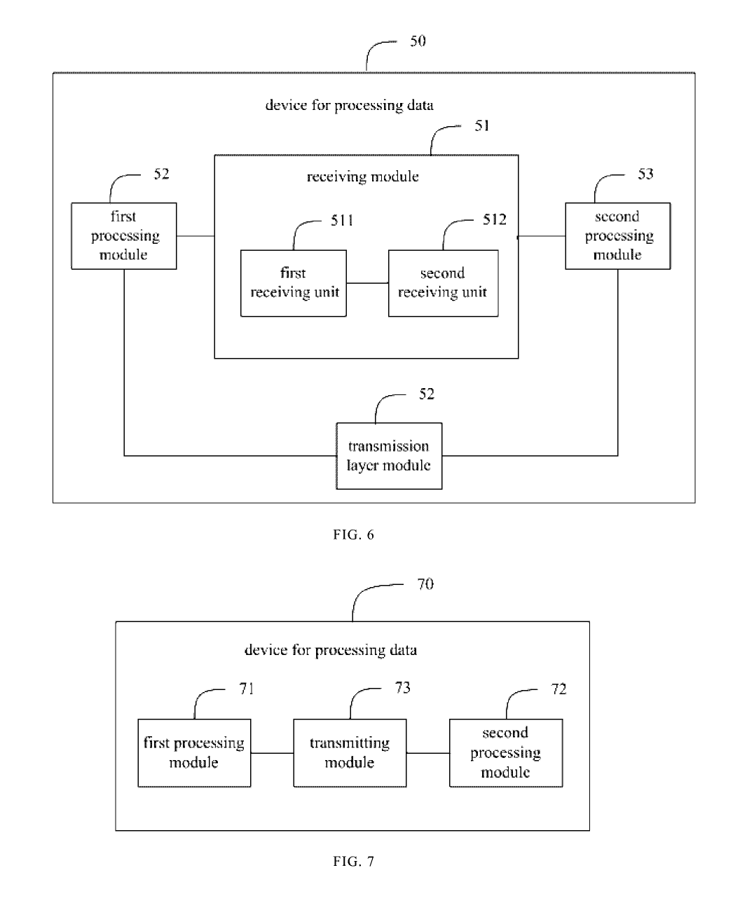

To clarify the present embodiment, the present embodiment further provides a possible implementation. FIG. 6 is a structural diagram of a possible implementation of the device for processing data 50. As shown in FIG. 6, based on the foregoing embodiments, the receiving module 51 of the device for processing data 50 in the present embodiment may further include: a first receiving unit 511 and a second receiving unit 512.

The first receiving unit 511 is configured to receive messages based on frequency point of WAVE protocol at physical layer upon first beacon frame is broadcast.

The second receiving unit 512 is configured to receive messages based on frequency point of Wi-Fi protocol at physical layer upon second beacon frame is broadcast.

More particularly, the time interval between broadcasting the first beacon frame and broadcasting the second beacon frame is n times of the time interval for broadcasting beacon frames in Wi-Fi protocol, wherein n is an integer equal to or greater than 1.

Furthermore, the device for processing data 50 may further include a transmission layer module 54.

The transmission layer module 54 is configured to be connected with the first processing module 52 and the second processing module 53, and to perform protocol processing on the first message using WSMP and/or TCP/IP protocol stack; to perform protocol processing on the second messages using TCP/IP protocol stack.

It should be noted that, the device according to the present embodiment is used to implement the flow of the method according to the first embodiment. The specific implementation of respect function modules may refer to the corresponding description in the embodiment of corresponding method, and would be omitted in the present embodiment.

In the present embodiment, by using TDM, messages are received and transmitted based on frequency points of WAVE protocol and Wi-Fi protocol respectively, at physical layer; a first message based on WAVE protocol is subject to protocol processing by using WAVE protocol stack at MAC layer; a second message based on Wi-Fi protocol is subject to protocol processing by using Wi-Fi protocol stack at MAC layer. By using such mariner of combining TDM and FDM, it is possible to realize integrated processing of messages based on different protocols, enabling the current wireless router based on Wi-Fi protocol to be compatible with WAVE protocol, thereby enriching the functions of current wireless router, avoiding separately deploying road-side devices only supporting WAVE protocol, and thus reducing the cost for networking of IOV.

### Fourth Embodiment

FIG. 7 is a structural diagram of a device for processing data 70 according to the fourth embodiment of the present disclosure. As shown in FIG. 7, the device for processing data 70 includes: a first processing module 71, a second processing module 72, and a transmitting module 73.

The first processing module 71 is configured to perform protocol processing on a first message to be transmitted based on the frequency point of WAVE protocol using WAVE protocol stack at MAC layer.

The second processing module 72 is configured to perform protocol processing on second messages to be transmitted based on the frequency point of Wi-Fi protocol using Wi-Fi protocol at MAC layer.

The transmitting module 73 is configured to be connected with the first processing module 71 and the second processing module 72, and to transmit the processed first messages based on the frequency point of WAVE protocol, and to transmit the processed second messages based on the frequency point of Wi-Fi protocol by using TDM at physical layer.

More particularly, the transmitting module 73 is configured to transmit the processed first messages based on frequency points of WAVE protocol and transmit the processed second messages based on frequency points of Wi-Fi protocol respectively, according to the period of the broadcasting beacon frames in Wi-Fi protocol.

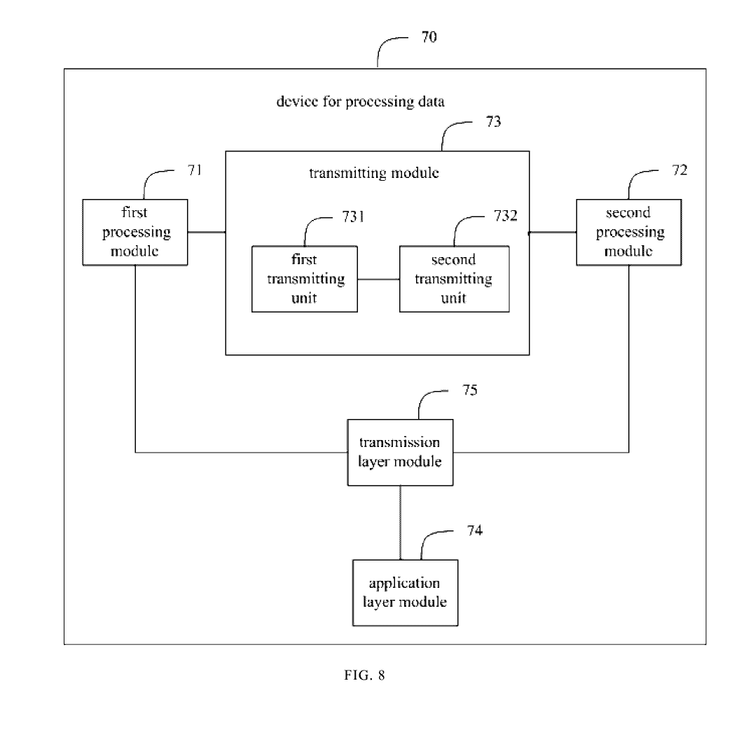

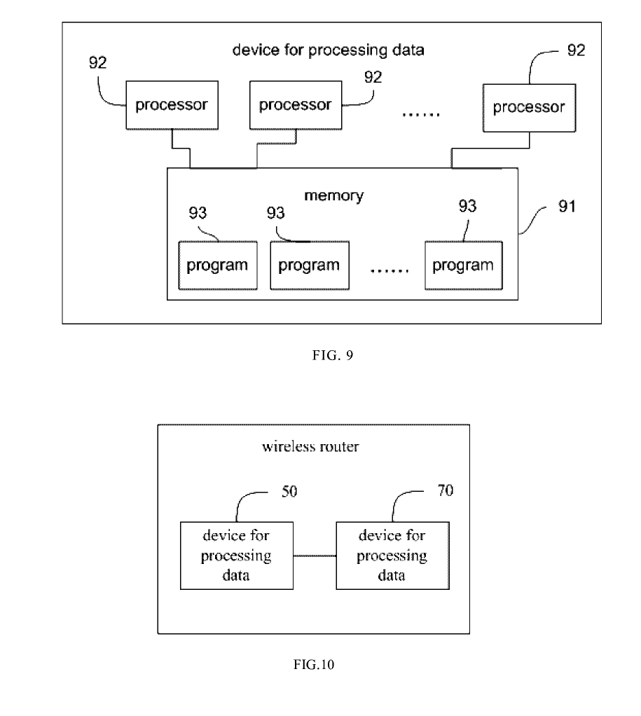

To better clarify the present embodiment, the present embodiment may further provide a possible implementation. FIG. 8 is a structural diagram of a possible implementation of the device for processing data 70. As shown in FIG. 8, based on the foregoing embodiments, the transmitting module 73 may be further configured to include a first transmitting unit 731 and a second transmitting unit 732.

The first transmitting unit 731 is configured to transmit the processed first messages based on the frequency point of WAVE protocol at the physical layer upon broadcasting the first beacon frame.

The second transmitting unit 732 is configured to transmit the processed second messages based on the frequency point of Wi-Fi protocol at the physical layer upon broadcasting the second beacon frame.

More particularly, the time interval between broadcasting the first beacon frame and broadcasting the second beacon frame is n times of the time interval for broadcasting beacon frames in Wi-Fi protocol, wherein n is an integer equal to or greater than 1.

Furthermore, the device for processing data 70 may be further configured to include an application layer module 74 and a transmission layer module 75.

The application layer module 74 may be configured to determine whether the messages to be transmitted are said first messages or said second messages at the application layer.

The Transmission layer module 75 may be configured to be connected with the application layer module 74, the first processing module 71, and the second processing module 72, and to process the first messages by using WSMP and/or TCP/IP protocol stack; and to process the second messages by using TCP/IP protocol stack.

It should be noted that, the device according to the present embodiment is used to implement the flow of the method according to the second embodiment. The specific implementation of respective function modules may refer to the corresponding description in the embodiment of corresponding method, and would be omitted in the present embodiment.

In the present embodiment, by using TDM, messages are received and transmitted based on frequency points of WAVE protocol and Wi-Fi protocol respectively, at physical layer; a first message based on the frequency point of WAVE protocol is subject to protocol processing by using WAVE protocol stack at MAC layer; a second message based on the frequency point of Wi-Fi protocol is subject to protocol processing by using Wi-Fi protocol stack at MAC layer. By using such manner of combining TDM and FDM, it is possible to realize integrated processing of messages based on different protocols, enabling the current wireless router based on Wi-Fi protocol to be compatible with WAVE protocol, thereby enriching the functions of current wireless router, avoiding separately deploying road-side devices only supporting WAVE protocol, and thus reducing the cost for networking of IOV.

### Fifth Embodiment

FIG. 10 is a structural diagram of the wireless router according to the fifth embodiment of the present disclosure. As shown in FIG. 10, the device for processing data 50 according to the foregoing third embodiment and the device for processing data 70 according to the foregoing fourth embodiment are shown.

As a wireless router for implementing the functions of wireless routing, it may not only implement the uplink of the data but also support the downlink of the data. Therefore, the wireless router may not only receive messages based on frequency point of WAVE protocol and frequency point of Wi-Fi protocol by using TDM at physical layer, perform protocol processing on the first message received based on frequency point of WAVE protocol using WAVE protocol stack at MAC layer, and perform protocol processing on the second message received based on frequency point of Wi-Fi protocol using Wi-Fi protocol stack at MAC layer, by using the device for processing data 50 according to the third embodiment, but also perform protocol processing on a first message to be transmitted based on the frequency point of WAVE protocol using WAVE protocol stack at MAC layer, perform protocol processing on second messages to be transmitted based on the frequency point of Wi-Fi protocol using Wi-Fi protocol at MAC layer, transmit the processed first messages based on the frequency point of WAVE protocol, and to transmit the processed second messages based on the frequency point of Wi-Fi protocol by using TDMat physical layer, by using the device for processing data 70 according to the fourth embodiment.

It can be seen that, the wireless router provided in the present embodiment may be obtained by modifying the convention wireless router based on Wi-Fi protocol, thereby enable the Wi-Fi wireless router to be compatible with WAVE protocol so as to implement DSRC communication. With such solution, there is no need to separately deploy road-side apparatus in IOV, and by using the Wi-Fi wireless router in the residences, stores, or public places on the road side, which may be compatible with WAVE protocol, that is the wireless router in the present embodiment, may realize the accessing of the on-vehicle device, and reduce the cost of networking of IOV.

It should be noted that, the wireless router according to the present embodiment is used to implement the flow of the method for processing data according to the first and second embodiments. The specific implementation of respect function modules may refer to the corresponding description in the corresponding embodiments, and would be omitted in the present embodiment.

In the present embodiment, by using TDM, messages are received and transmitted based on frequency points of WAVE protocol and Wi-Fi protocol respectively, at physical layer; a first message based on the frequency point of WAVE protocol is subject to protocol processing by using WAVE protocol stack at MAC layer; a second message based on the frequency point of Wi-Fi protocol is subject to protocol processing by using Wi-Fi protocol stack at MAC layer. By using such manner of combining TDM and FDM, it is possible to realize integrated processing of messages based on different protocols, enabling the current wireless router based on Wi-Fi protocol to be compatible with WAVE protocol, thereby enriching the functions of current wireless router, avoiding separately deploying road-side devices only supporting WAVE protocol, and thus reducing the cost for networking of IOV.

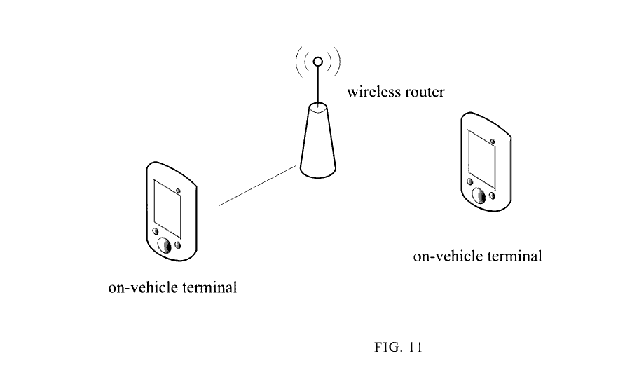

FIG. 11 is a structural diagram of the IOV. As shown in FIG. 11, the wireless router provided in the foregoing fifth embodiment and on-vehicle terminal are shown, wherein there is communication connection established between the on-vehicle terminal and the wireless router.

On one hand, the wireless router may implement the receiving of data. The on-vehicle terminal and mobile phone terminal based on Wi-Fi communication perform transmission of messages based on their respective supported protocols. The wireless router which has established communication connection with on-vehicle terminal and mobile phone terminal may receive and transmit messages based on frequency points of WAVE protocol and Wi-Fi (Wireless Fidelity) protocol, respectively, by using TDMat physical layer; perform protocol processing on a first message received based on the frequency point of WAVE protocol by using WAVE protocol stack at MAC layer; perform protocol processing on a second message received based on the frequency point of Wi-Fi protocol by using Wi-Fi protocol stack at MAC layer.

On the other hand, the wireless may implement the transmission of data. The wireless router may perform processing on first messages by using WSMP and/or TCP/IP protocol stack and perform processing on the second messages by using TCP/IP protocol stack after it is determined that the messages to be transmitted are said first messages or said second messages. The first messages to be transmitted based on frequency point of WAVE protocol may be subject to protocol processing by using WAVE protocol at MAC layer; the second messages to be transmitted based on frequency point of Wi-Fi protocol may be subject to protocol processing by using Wi-Fi protocol at MAC layer; the processed first messages may be transmitted based on the frequency point of WAVE protocol, and the processed second messages may be transmitted based on the frequency point of Wi-Fi protocol by using TDM at physical layer.

It is possible to realize compatibility between the WAVE protocol defined in Institute of Electrical and Electronic Engineers (IEEE)802.11p and the Wi-Fi protocol defined in IEEE802.11 by using TDM mode, thereby the wireless router may support not only WAVE protocol, but also Wi-Fi protocol. The technical solution according to the present embodiment can be regarded as taking a part of time which was supposed to be used to perform Wi-Fi communication by wireless router to perform WAVE communication, and thus with respect to the wireless terminal having established Wi-Fi communication connection with the wireless router, the communication rate is reduced by 50%. When the wireless router receives messages based on Wi-Fi protocol, the on-vehicle terminal having established WAVE communication connection with the wireless router would not disconnect the communication connection, that is to say, the communication link is in communication state and only the data communication is in standby state, which means there is no data transmission and reception between the on-vehicle terminal and wireless router.

In the present embodiment, by using TDM, messages are received and transmitted based on frequency point of WAVE protocol and Wi-Fi (Wireless Fidelity) protocol respectively at physical layer; a first message received based on the frequency point of WAVE protocol is subject to protocol processing by using WAVE protocol stack at MAC layer; a second message received based on the frequency point of Wi-Fi protocol is subject to protocol processing by using Wi-Fi protocol stack at MAC layer. By using such manner of combining TDM and FDM, it is possible to realize integrated processing of messages based on different protocols, enabling the current wireless router based on Wi-Fi protocol to be compatible with WAVE protocol, thereby enriching the functions of current wireless router, avoiding separately deploying road-side devices only supporting WAVE protocol, and thus reducing the cost for networking of IOV.

One skilled in the art would appreciate that all or a part of the steps for implementing the foregoing method embodiments may be implemented by hardware related to program instructions. Foregoing programs may be stored in computer-readable storage medium, and upon being executed, such programs may perform the steps including foregoing method embodiments; and examples of foregoing storage medium include ROM, RAM, CD-ROM, a magnetic tape, and the other types of storage mediums which may store the program codes.

It should be noted that the foregoing embodiments are merely used to illustrate the technical solution of the present disclosure, and not to limit the present disclosure. Although the present disclosure has been described in detail with reference to the foregoing embodiments, one skilled in the art would understand that the technical solutions recited in the foregoing embodiments may be modified or all or a part of the technical features may be replaced equally. These modifications and replacements are not intended to make corresponding technical solution depart from the scope of the technical solution of embodiments of the present disclosure.

What is claimed is:

1. A method for processing data, comprising:
receiving messages based on frequency points of Wireless Access in Vehicular Environment protocol and Wireless Fidelity protocol using Time Division Multiplexing at physical layer respectively;
performing protocol processing on a first message received based on the frequency point of WAVE protocol using WAVE protocol stack at Media Access Control layer; and
performing protocol processing on a second message received based on the frequency point of Wi-Fi protocol using Wi-Fi protocol stack at said MAC layer.

2. The method for processing data according to claim 1, wherein the receiving messages based on frequency points of WAVE protocol and Wi-Fi protocol respectively using TDM at physical layer comprises:
receiving messages based on frequency points of WAVE protocol and Wi-Fi protocol respectively at physical layer according to a period of broadcasting beacon frames in Wi-Fi protocol.

3. The method for processing data according to claim 2, wherein the receiving messages based on frequency points of WAVE protocol and Wi-Fi protocol respectively at physical layer according to the period of the broadcasting beacon frames in Wi-Fi protocol comprises:
receiving messages based on frequency point of WAVE protocol at said physical layer upon broadcasting the first beacon frame; and
receiving messages based on frequency point of Wi-Fi protocol at physical layer upon broadcasting a second beacon frame,
wherein the time interval between broadcasting the first beacon frame and broadcasting the second beacon frame is n times of the time interval for broadcasting beacon frames in Wi-Fi protocol, wherein n is an integer equal to or greater than 1.

4. The method for processing data according to claim 1, further comprising:
performing protocol processing on the first message using WSMP (WAVEShortMessageProtocol) and/or TCP/IP (Transmission Control Protocol/Internet Protocol) protocol stack; and
performing protocol processing on the second message using TCP/IP protocol stack.

5. A method for processing data, comprising:
performing protocol processing on a first message to be transmitted based on the frequency point of WAVE protocol using WAVE protocol stack at MAC layer, performing protocol processing on a second message to be transmitted based on the frequency point of Wi-Fi protocol using Wi-Fi protocol at said MAC layer; and
transmitting the processed first message based on the frequency point of WAVE protocol, and transmitting the processed second message based on the frequency point of Wi-Fi protocol using TDM at physical layer.

6. The method for processing data according to claim 5, wherein the transmitting the processed first message based on the frequency point of WAVE protocol, and transmitting the processed second message based on the frequency point of Wi-Fi protocol using TDM at physical layer comprises:
transmitting the processed first message based on frequency point of WAVE protocol and transmitting the processed second message based on frequency point of Wi-Fi protocol respectively, according to the period of the broadcasting beacon frames in Wi-Fi protocol.

7. The method for processing data according to claim 6, wherein the transmitting the processed first message based on frequency point of WAVE protocol and transmitting the processed second message based on frequency point of Wi-Fi protocol respectively, according to the period of the broadcasting beacon frames in Wi-Fi protocol comprises:
transmitting the processed first message based on frequency point of WAVE protocol at said physical layer upon broadcasting a first beacon frame; and
transmitting the processed second message based on frequency point of Wi-Fi protocol at said physical layer upon broadcasting a second beacon frame,
wherein the time interval between broadcasting the first beacon frame and broadcasting the second beacon frame is n times of the time interval for broadcasting beacon frames in Wi-Fi protocol, wherein n is an integer equal to or greater than 1.

8. The method for processing data according to claim 5, further comprising:
determining whether the message to be transmitted is said first message or said second message at application layer;
performing processing on said first message using WSMP and/or TCP/IP protocol stack; and
performing processing on said second message using TCP/IP protocol stack.

9. A device for processing data, comprising:
one or more processors;
a memory; and
one or more programs stored in the memory and configured to perform operations when executed by the one or more processors, wherein the operations comprises:
receiving messages based on frequency points of Wireless Access in Vehicular Environment protocol and Wireless Fidelity protocol using Time Division Multiplexing at physical layer respectively;
performing protocol processing on a first message received based on the frequency point of WAVE protocol using WAVE protocol stack at Media Access Control layer; and
performing protocol processing on a second message received based on the frequency point of Wi-Fi protocol using Wi-Fi protocol stack at said MAC layer.

10. The device for processing data according to claim 9, wherein, the operation of receiving messages based on frequency points of Wireless Access in Vehicular Environment protocol and Wireless Fidelity protocol using Time Division Multiplexing at physical layer respectively further comprises receiving messages based on frequency point of WAVE protocol and frequency point of Wi-Fi protocol respectively at physical layer according to the period of broadcasting beacon frames in Wi-Fi protocol.

11. The device for processing data according to claim 10, wherein the operation of receiving messages based on frequency points of Wireless Access in Vehicular Environment protocol and Wireless Fidelity protocol using Time Division Multiplexing at physical layer respectively further comprises:
receiving messages based on frequency point of WAVE protocol at physical layer upon a first beacon frame is broadcast; and
receiving message based on frequency point of Wi-Fi protocol at physical layer upon a second beacon frame is broadcast;
wherein the time interval between broadcasting the first beacon frame and broadcasting the second beacon frame is n times of the time interval for broadcasting beacon frames in Wi-Fi protocol, wherein n is an integer equal to or greater than 1.

12. The device for processing data according to claim 9, wherein the operations further comprise:
performing protocol processing on the first message using WSMP and/or TCP/IP protocol stack, and perform protocol processing on the second message using TCP/IP protocol stack.

13. A device for processing data, comprising:
one or more processors;
a memory; and
one or more programs stored in the memory and configured to perform operations when executed by the one or more processors, wherein the operations comprises:
performing protocol processing on a first message to be transmitted based on the frequency point of WAVE protocol using WAVE protocol stack at MAC layer;
performing protocol processing on a second message to be transmitted based on the frequency point of Wi-Fi protocol using Wi-Fi protocol stack at MAC layer; and
transmitting the processed first message based on the frequency point of WAVE protocol, and transmitting the processed second message based on the frequency point of Wi-Fi protocol by using TDM at physical layer.

14. The device for processing data according to claim 13, wherein the operation of transmitting the processed first message based on the frequency point of WAVE protocol, and transmitting the processed second message based on the frequency point of Wi-Fi protocol by using TDM at physical layer further comprises transmitting the processed first message based on frequency point of WAVE protocol and transmit the processed second message based on frequency point of Wi-Fi protocol respectively, according to the period of the broadcasting beacon frames in Wi-Fi protocol.

15. The device for processing data according to claim 14, wherein the operation of transmitting the processed first message based on the frequency point of WAVE protocol, and transmitting the processed second message based on the frequency point of Wi-Fi protocol by using TDM at physical layer further comprises:
transmitting the processed first message based on the frequency point of WAVE protocol at the physical layer upon broadcasting a first beacon frame; and
transmitting the processed second message based on the frequency point of Wi-Fi protocol at the physical layer upon broadcasting a second beacon frame,
wherein the time interval between broadcasting the first beacon frame and broadcasting the second beacon frame is n times of the time interval for broadcasting beacon frames in Wi-Fi protocol, wherein n is an integer equal to or greater than 1.

16. The device for processing data according to claim 13, wherein the operations further comprises:
determining whether the message to be transmitted is said first messages or said second messages at the application layer; and
processing the first message by using WSMP and/or TCP/IP protocol stack; and processing the second message by using TCP/IP protocol stack.

17. A wireless router comprising a device for processing data which includes:
one or more processors;
a memory; and
one or more programs stored in the memory and configured to perform operations when executed by the one or more processors, wherein the operations comprises:
receiving messages based on frequency points of Wireless Access in Vehicular Environment protocol and Wireless Fidelity protocol using Time Division Multiplexing at physical layer respectively;
performing protocol processing on a first message received based on the frequency point of WAVE protocol using WAVE protocol stack at Media Access Control layer; and
performing protocol processing on a second message received based on the frequency point of Wi-Fi protocol using Wi-Fi protocol stack at said MAC layer.

18. A wireless router according to claim 17, wherein the operations of the device for processing data further comprise:
transmitting the processed first message based on the frequency point of WAVE protocol, and transmitting the processed second message based on the frequency point of Wi-Fi protocol by using TDM at physical layer.

19. An Internet of Vehicles system, comprising the wireless router according to claim 17, and an on-vehicle terminal,
wherein there is a communication connection established between said on-vehicle terminal and said wireless router.
